(19) United States
(12) Patent Application Publication
(10) Pub. No.: US 2026/0183909 A1
(43) Pub. Date: Jul. 2, 2026

(54) ELECTRIC TOOL

(71) Applicant: PANASONIC HOLDINGS CORPORATION, Osaka (JP)

(72) Inventors: Masamichi NAKAMURA, Shiga (JP); Keita OKAMOTO, Mie (JP)

(21) Appl. No.: 18/858,669

(22) PCT Filed: Apr. 10, 2023
(86) PCT No.: PCT/JP2023/014522

§ 371 Date: Oct. 21, 2024

(30) Foreign Application Priority Data
Apr. 27, 2022 (JP) 2022-073604

(51) Int. Cl. B25B 23/147; B25B 23/00; B25F 5/00; B25F 5/02; F21V 33/00

(52) U.S. Cl. CPC B25B 23/147; B25B 23/0035; B25F 5/001; B25F 5/02; F21V 33/0084

(57) ABSTRACT

An electric tool includes a motor, a holder, a display, and a housing. The motor is configured to perform rotation operation. The holder is configured to hold a tip tool to which a rotational force is to be transmitted from the motor. The display is configured to display a state of a fastening operation of fastening a fastening part to a work target by the tip tool. The housing houses the motor. The housing includes a grip and a stopper. The grip has an elongated shape and is configured to be gripped by a person. The stopper is disposed at an end of the grip, the end being located at a side of the holder, the stopper protruding beyond the end in a protrusion direction intersecting a longitudinal direction of the grip. The display is disposed on the stopper.

### TECHNICAL FIELD

The present disclosure generally relates to electric tools. The present disclosure specifically relates to an electric tool configured to perform a fastening operation of fastening a fastening part to a work target.

### Background Art

Patent Literature 1 discloses a rotary tool including a motor control means, a screw fastening tool, a rotation angle detection means, a fastening determination means, and a screw length determination means. The motor control means controls rotation and deactivation of a motor. The screw fastening tool is rotated by a rotation output transmitted thereto from the motor via an impact mechanism. The rotation angle detection means detects the angle of rotation of one of the motor and the tool. The fastening determination means determines fastening torque of a screw from the angle of rotation of the screw between generation timings of an impact force by the impact mechanism, and when the fastening torque reaches a specified value, the fastening determination means instructs the motor control means to deactivate the motor. When the deactivation of the motor is instructed by the fastening determination means, if an integrated value of the angles of rotation detected by the rotation angle detection means since a start of fastening of one screw is within a set range according to the specification of the one screw, the screw length determination means determines that the integrated value is normal.

Patent Literature 1 discloses that a determination result by the screw length determination means is announced by visual annunciation using a lamp (display). However, Patent Literature 1 fails to disclose a specific installation location of the lamp. Depending on the installation location of the lamp, it may become difficult for a user of the rotary tool (electric tool) to check the determination result when the user fastens a screw (performs a fastening operation).

### CITATION LIST

### Patent Literature

Patent Literature 1: JP 4882802 B2

### SUMMARY OF INVENTION

It is an object of the present disclosure to provide an electric tool configured to further facilitate checking a state of a fastening operation.

An electric tool according to an aspect of the present disclosure includes a motor, a holder, a display, and a housing. The motor is configured to perform rotation operation. The holder is configured to hold a tip tool to which a rotational force is to be transmitted from the motor. The display is configured to display a state of a fastening operation of fastening a fastening part to a work target by the tip tool. The housing houses the motor. The housing includes a grip and a stopper. The grip has an elongated shape and is configured to be held by a person. The stopper is disposed at an end of the grip, the end being at a side of the holder, the stopper protruding beyond the end in a protrusion direction intersecting a longitudinal direction of the grip. The display is disposed on the stopper.

### BRIEF DESCRIPTION OF DRAWINGS

FIG. 1 is a front view of an electric tool of the present embodiment;

FIG. 2 is a block diagram of a schematic configuration of the electric tool;

FIG. 3 is a back view of the electric tool;

FIG. 4 is an illustrative view of an inner structure of the electric tool;

FIG. 5 is a perspective view of the display; and

FIG. 6 is a sequence diagram of operation of the electric tool.

### DESCRIPTION OF EMBODIMENTS

An electric tool according to an embodiment of the present disclosure will be described in detail below with reference to the drawings. Note that figures described in the following embodiment are schematic views, and the ratio of sizes and the ratio of thicknesses of components do not necessarily reflect actual dimensional ratios. Note that a configuration described in the following embodiment is a mere example of the present disclosure. The present disclosure is not limited to the following embodiment, and various modifications may be made based on design and the like as long as the effect of the present disclosure is achieved.

### Present Embodiment

### (1) Overview

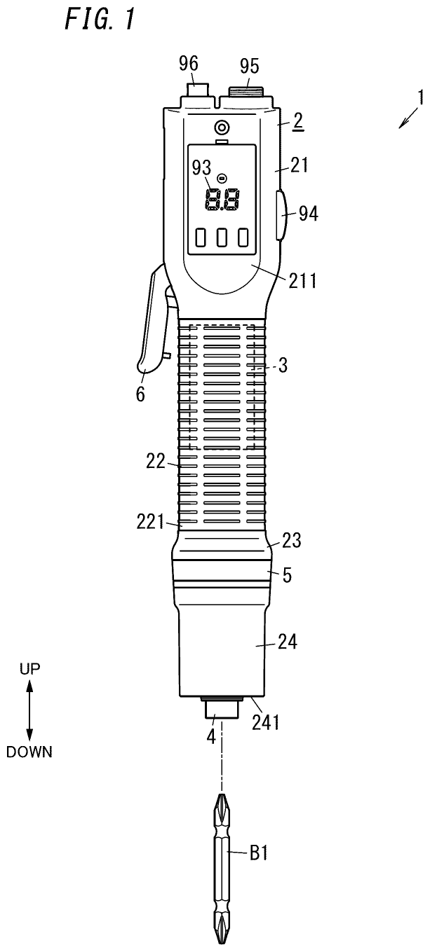

An overview of an electric tool 1 according to the present embodiment will be described below with reference to FIG. 1.

As shown in FIG. 1, the electric tool 1 according to a first embodiment includes a motor 3, a holder 4, a display 5, and a housing 2. In the following description, a worker is assumed to use the electric tool 1 to perform a fastening operation of fastening a fastening part(such as a screw, a bolt, or a nut) to a work target (such as an electric appliance or furniture).

The motor 3 performs rotation operation. The holder 4 holds a tip tool B1 to which a rotational force is to be transmitted from the motor 3. The display 5 displays a state of the fastening operation of fastening the fastening part to the work target by the tip tool B1.

The housing 2 includes a grip 22 and a stopper 23. The grip 22 has an elongated shape and is to be held by a person (e.g., the worker). The stopper 23 is disposed at an end 221 of the grip 22. The end 221 is located at the side of the holder 4. The stopper 23 protrudes beyond the end 221 in a protrusion direction intersecting a longitudinal direction of the grip 22. The display 5 is disposed on the stopper 23.

In general, the worker gazes the fastening part or the tip tool B1 during the fastening operation. Therefore, in the present embodiment, the display 5 is disposed on the stopper 23 which is closer to the tip tool B1 than the grip 22 is, and thereby, the worker can check the state of the fastening operation without widely moving his/her eyes from the fastening part or the tip tool B1 at the end of the fastening operation.

Moreover, in the present embodiment, the stopper 23 can prevent the display 5 from being uncheckable due to the cause that when the worker pushes the electric tool 1 against the fastening part during the fastening operation, the hand of the worker gripping the grip 22 moves toward the holder 4 and covers the display 5.

Thus, the electric tool 1 of the present embodiment has the advantage that checking the state of the fastening operation is further facilitated.

### (2) Detailed Configuration

### (2-1) Overall Structure

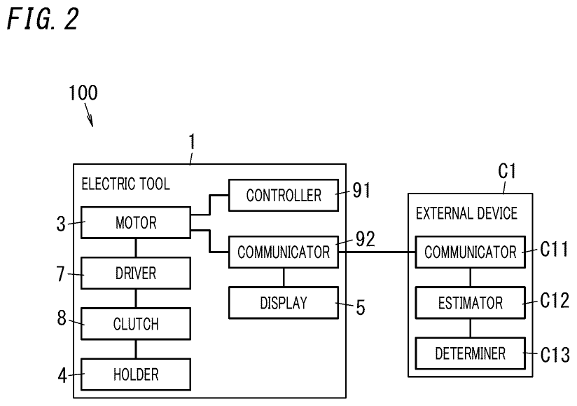

With reference to FIG. 2, a detailed configuration of an electric tool system 100 of the present embodiment will be described below.

As shown in FIG. 2, the electric tool system 100 of the present embodiment includes the electric tool 1 and an external device C1.

### (2-2) Electric Tool

With reference to FIGS. 1 to 4, a detailed configuration of the electric tool 1 of the present embodiment will be described below.

As shown in FIGS. 1 and 2, the electric tool 1 includes the housing 2, the motor 3, the holder 4, the first display 5, an operating member 6, a driver 7, a clutch 8, a control circuit 91, a communication interface 92, a second display 93, a forward reverse switch 94, a power supply connector 95, and a communication connector 96. The first display 5 corresponds to a display of the present invention.

In the electric tool 1 of the present embodiment, the grip 22 and the holder 4 are aligned with each other along a longitudinal direction, which will be described later, of the grip 22. That is, the electric tool 1 of the present embodiment is a vertical electric tool. Note that the electric tool 1 may be a collapsible electric tool as long as it is an electric tool configured to perform the fastening operation in the state where the grip 22 and the holder 4 are aligned with each other along the longitudinal direction of the grip 22.

In the following description, the longitudinal direction of the grip 22 is defined as an up/down direction, the holder 4 is defined to be located downward of the grip 22, and the grip 22 is defined to be located upward of the holder 4.

### (2-2-1) Housing

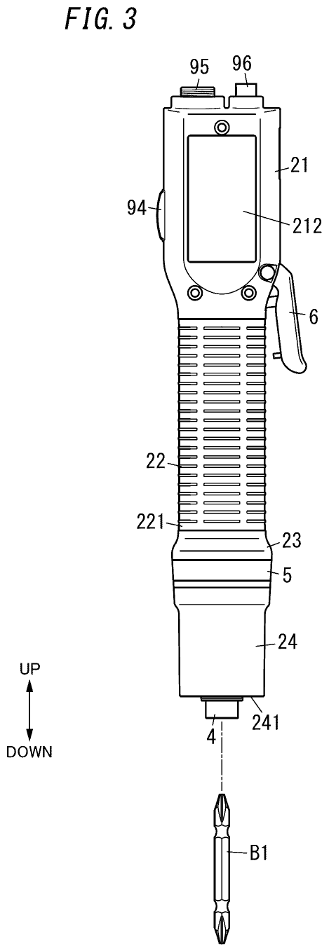

As shown in FIGS. 1 and 3, the housing 2 includes a first part 21, the grip 22, the stopper 23, and the second part 24.

### First Part

The first part 21 is in the shape of a substantially rectangular parallelepiped. The first part 21 houses the control circuit 91 and the communication interface 92. The first part 21 has a surface 211 (see FIG. 1) and a back surface 212 (see FIG. 3) as two surfaces facing each other. On the surface 211, the second display 93 is disposed.

### Grip

The grip 22 has an elongated shape and is to be gripped by a person. The worker can grip the grip 22 to perform the fastening operation. The grip 22 protrudes downward from a lower end of the first part 21. The grip 22 of the present embodiment is cylindrical. The grip 22 of the present embodiment houses the motor 3 and at least part of the driver 7.

### Stopper

As shown in FIG. 1, the stopper 23 is disposed at the end 221 of the grip 22. The end 221 is located at the side of the holder 4. That is, the stopper 23 is disposed at the end 221 at a lower side of the grip 22.

The stopper 23 protrudes beyond the end 221 of the grip 22 in the protrusion direction intersecting the longitudinal direction (the up/down direction in FIG. 1) of the grip 22. In the present embodiment, the stopper 23 protrudes in the protrusion direction from the entire circumference of the end 221 of the grip 22. In other words, the stopper 23 protrudes in the protrusion direction in one round of the end 221 of the grip 22. This configuration provides the effect that the hand of the worker is further suppressed from slipping downward from the grip 22 during the fastening operation. That is, there is the advantage that the first display 5 disposed on the stopper 23 is further suppressed from being hidden by the hand of the worker during the fastening operation.

The protrusion direction of the stopper 23 of the present embodiment is a direction vertical to the longitudinal direction of the grip 22. The stopper 23 of the present embodiment has a circularly annular shape. In the present embodiment, the stopper 23 has an outer diameter greater than an outer diameter of the grip 22.

### Second Part

The second part 24 protrudes downward from a lower end of the stopper 23. The second part 24 is in the shape of a cylinder whose bottom has an opening 241. The second part 24 houses the clutch 8 and at least part of the driver 7.

### (2-2-2) Motor

As shown in FIG. 1, the motor 3 is housed in a lower portion of the grip 22. The motor 3 includes: a rotor having a rotary shaft and a permanent magnet; and a stator having a coil. Electromagnetic interaction between the permanent magnet and the coil rotates the rotor with respect to the stator. As a result, the motor 3 performs the rotation operation.

The torque and the rotational velocity of the motor 3 change in accordance with control by the control circuit 91 (servo driver). More specifically, the control circuit 91 controls the operation of the motor 3 by feedback control of controlling such that the torque and the rotational velocity of the motor 3 approach respective target values.

### (2-2-3) Driver

The driver 7 includes a planet gear mechanism connected to the rotary shaft of the motor 3. As a result, the driver 7 rotates in interconnection with the rotary shaft of the motor 3. That is, the driver 7 is rotated by the motor 3. The driver 7 is housed in the grip 22, the stopper 23, and the second part 24.

The planet gear mechanism converts the rotational velocity and the torque of the rotary shaft of the motor 3 respectively into a rotational velocity and a torque required for the operation of turning a screw. The planet gear mechanism is a deceleration device. The torque of the rotary shaft of the motor 3 is transmitted from the planet gear mechanism to the driver 7.

### (2-2-4) Clutch

When a fastening torque value of the fastening operation reaches the target value, the clutch 8 mechanically interrupts the transmission of the rotational force to the tip tool B1. In the clutch 8 of the present embodiment, the worker turns a dial ring (not shown) disposed on a side surface of the clutch 8, thereby manually setting the target value of the fastening torque value. To mechanically interrupts the transmission of the rotational force to the tip tool B1 when the fastening torque value of the fastening operation reaches the target value, the clutch 8 of the present embodiment disconnects a mechanical connection between the driver 7 and the holder 4. As used in the present disclosure, the “fastening torque value” is the value of torque applied to the fastening part by the tip tool B1 in the fastening operation.

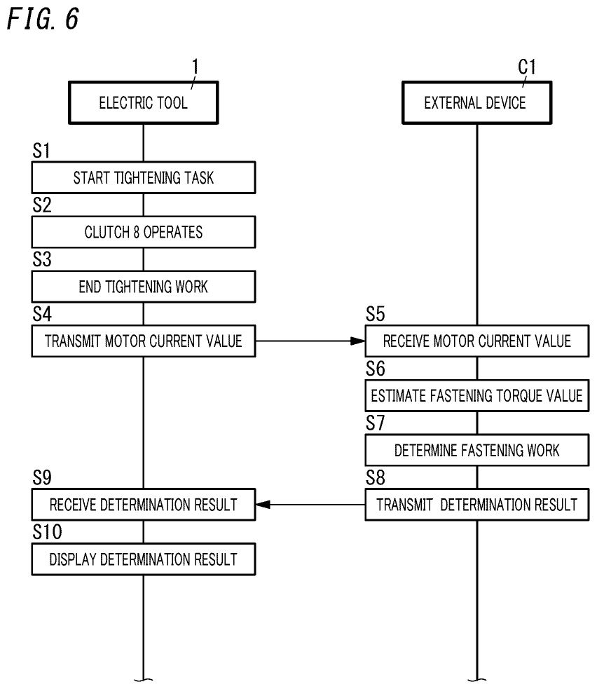

The clutch 8 is housed in the second part 24. That is, as shown in FIG. 6, the clutch 8 is disposed between the stopper 23 and the holder 4. This configuration provides the effect that the distance between the holder 4 and the first display 5 to be increased. As a result, even when a part of the work target to which the fastening part is to be fastened is recessed, the first display 5 is suppressed from being hidden by the work target.

### (2-2-5) Holder

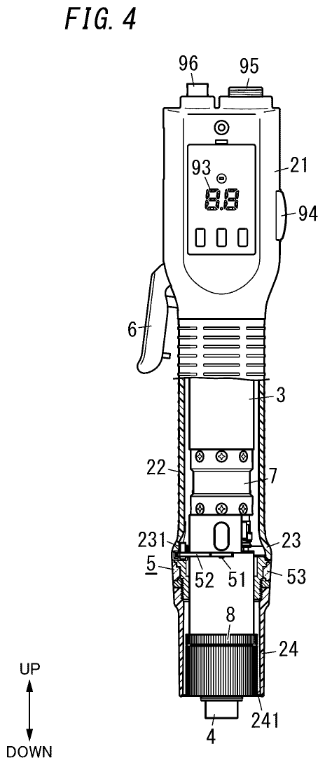

The holder 4 holds the tip tool B1 to which the rotational force is to be transmitted from the motor 3. As shown in FIG. 4, the holder 4 is disposed on an end surface of the clutch 8. The end surface is exposed from the opening 241 of the second part 24. That is, the holder 4 is disposed on a lower end surface of the clutch 8. The holder 4 is rotated together with the tip tool B1 by the motor 3.

In the present embodiment, the tip tool B1 (FIG. 1) is detachably and directly attached to the holder 4. Note that the holder 4 may have a chuck to which the tip tool B1 is removably attached. Moreover, the holder 4 may be integrally formed with the tip tool B1. The tip tool B1 is, for example, a driver bit. The holder 4 rotates in the state where the tip tool B1 is fit to the fastening part, thereby enabling an operation such as fastening or loosening the fastening part.

### (2-2-6) Communication Interface

The communication interface 92 communicates with a communication interface C11, which will be described later, of the external device C1. The communication interface 92 of the present embodiment communicates via a communication cable with the communication interface C11 of the external device C1.

In the present embodiment, the communication interface 92 transmits, to the communication interface C11 of the external device C1, data on a motor current value which is the value of a current flowing through the motor 3. More specifically, the motor current value is the value of a current which flows through the motor 3 when the clutch 8 operates.

Moreover, the communication interface 92 of the present embodiment receives a determination result by a determiner C13 of the external device C1 from the communication interface C11 of the external device C1. That is, the communication interface 92 of the present embodiment receives, from the external device C1, the determination result as to whether or not the fastening operation has normally been performed. The communication interface 92 of the present embodiment outputs the determination result thus received to the first display 5.

### (2-2-7) Display

The first display 5 displays the state the fastening operation of fastening the fastening part to the work target by the tip tool B1. The first display 5 of the present embodiment displays whether or not the fastening operation has normally been performed. More specifically, the first display 5 of the present embodiment displays the determination result by the external device C1 as to whether or not the fastening operation has normally been performed.

The first display 5 is disposed on the stopper 23. In general, the worker gazes the fastening part or the tip tool B1 during the fastening operation. Therefore, disposing the first display 5 on the stopper 23, which is located closer to the tip tool B1 than the grip 22 is, provides the advantage that the worker can check the state of the fastening operation without widely moving his/her eyes from the fastening part or the tip tool B1 at the end of the fastening operation.

Moreover, the configuration that the first display 5 is disposed on the stopper 23 can suppress the hand of the worker gripping the grip 22 from moving toward the holder 4 and from covering the first display 5 when the worker pushes the electric tool 1 against the fastening part during the fastening operation. That is, there is also the advantage that the first display 5 can be prevented from being uncheckable.

Further, with this configuration, the first display 5 is disposed on the stopper 23 protruding in the protrusion direction intersecting the longitudinal direction of the grip 22. Therefore, even when a part of the work target to which the fastening part is to be fastened is recessed, the first display 5 is suppressed from being hidden by the work target. That is, there is the advantage that checking the state of the fastening operation is further facilitated.

The first display 5 of the present embodiment is disposed on the entire circumference of an outer surface of the stopper 23. That is, the first display 5 of the present embodiment has a shape extending over the entire circumference of the outer surface of the stopper 23 as shown in FIGS. 1 and 3. More specifically, the first display 5 has a shape extending one round along a circumferential direction of the outer surface of the stopper 23. In other words, the first display 5 of the present embodiment has a circularly annular shape along the circumferential direction of the outer surface of the stopper 23. This configuration provides the advantage that the worker can check the state of the fastening operation regardless of the position which the worker performing the fastening operation takes.

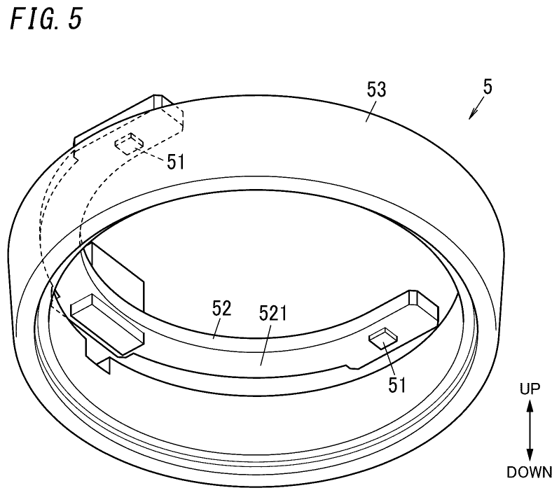

The first display 5 of the present embodiment is configured to output light in a plurality of colors individually. More specifically, the first display 5 of the present embodiment includes two light-emitting elements 51, a holding pedestal 52, and a transmission cover 53 as shown in FIGS. 4 and 5.

The two light-emitting elements 51 each output light in a plurality of colors individually. For example, each of the two light-emitting elements 51 is a color-tunable LED element.

The transmission cover 53 transmits light output from each of the two light-emitting elements 51 to the outside of the electric tool 1. As shown in FIG. 5, the transmission cover 53 has a circularly annular shape. The transmission cover 53 has a blasted outer surface so that light output from the light-emitting elements 51 is diffused. The “outer surface of the transmission cover 53” as used herein is a side surface which is one of side surfaces of the transmission cover 53 and which does not face the light-emitting elements 51. As shown in FIG. 4, the transmission cover 53 of the present embodiment is disposed at a center part of the stopper 23 in the up/down direction.

The holding pedestal 52 holds each of the two light-emitting elements 51. In the present embodiment, the two light-emitting elements 51 and the holding pedestal 52 are disposed at an upper portion of the stopper 23 in the up/down direction. That is, in the present embodiment, the two light-emitting elements 51 and the holding pedestal 52 are disposed at an upper end of the transmission cover 53. As shown in FIG. 5, the holding pedestal 52 of the present embodiment is a U-shaped plate member which curves along the circumferential direction of the transmission cover 53. The holding pedestal 52 has a U-shaped inner edge extending along an outer perimeter of the driver 7. The holding pedestal 52 of the present embodiment has a lower surface 521 which is a surface facing the transmission cover 53 in the up/down direction, and the holding pedestal 52 holds the two light-emitting elements 51 on the lower surface 521. More specifically, the holding pedestal 52 holds the two light-emitting elements 51 on the lower surface 521 such that the two light-emitting elements 51 are disposed with a 180 degree-interval along the circumferential direction of the transmission cover 53. That is, the two light-emitting elements 51 are disposed along the outer perimeter of the driver 7 with an interval of 180 degrees. The stopper 23 has a groove 231 (see FIG. 4) which is located at an upper portion of an inner surface of the stopper 23 and which extends in a circumferential direction of the stopper 23. The two light-emitting elements 51 and the holding pedestal 52 are fixed to the stopper 23 by fitting an outer edge of the stopper 23 in the groove 231.

The first display 5 switches, in accordance with the state of the fastening operation, the color of light output therefrom to any one of the plurality of colors. This configuration has the advantage that the worker can easily check the state of the fastening operation. The first display 5 of the present embodiment switches, depending on whether or not the fastening operation has normally been performed, the color of light output therefrom to any one of the plurality of colors.

Specifically, the switching of the color of light output from the first display 5 will be described.

Each of the light-emitting elements 51 of the present embodiment can output green light and red light. That is, the first display 5 of the present embodiment is configured to output green light and red light. If the estimator C12 determines that the fastening operation has normally been performed, the first display 5 of the present embodiment outputs the green light. In contrast, if the estimator C12 determines that the fastening operation has not normally been performed, the first display 5 of the present embodiment outputs the red light.

### (2-2-8) Operating Member

The operating member 6 is disposed on a side surface of the first part 21. More specifically, the operating member 6 is disposed to protrude downward from the side surface of the first part 21 as shown in FIGS. 1 and 3. The operating member 6 receives an operation for controlling the rotation of the motor 3. The worker gives an operation of tilting the operating member 6 toward the grip 22, thereby switching ON/OFF of the rotation of the motor 3. Moreover, a pulled amount of the operating member 6 indicating how much the operating member 6 is tilted can an adjust the rotational velocity of the motor 3. The greater the pulled amount is, the higher the rotational velocity of the motor 3.

### (2-2-9) Forward Reverse Switch

The forward reverse switch 94 is a switch for switching a rotational direction of the motor 3. As shown in FIGS. 1 and 3, the forward reverse switch 94 of the present embodiment is disposed on a side surface which is one of side surfaces of the first part 21 and on which the operating member 6 is not disposed.

### (2-2-10) Control Circuit

The control circuit 91 rotates or deactivates the motor 3 or controls the rotational velocity of the motor 3 in accordance with the operation of tilting the operating member 6. Moreover, the control circuit 91 controls the rotational direction of the motor 3 in accordance with a position of the forward reverse switch 94.

The control circuit 91 includes, for example, a microcontroller. The operating member 6 changes the rotational velocity of the motor 3, thereby changing the rotational velocity of the driver 7 and the tip tool B1. The control circuit 91 changes, for example, electric power to be supplied to the motor 3, thereby changing the rotational velocity of the motor 3.

### (2-2-11) Numerical Digit Display

The second display 93 is configured to display numerical digits or alphabets. As shown in FIG. 1, the second display 93 of the present embodiment is a 7-segment LED display. The second display 93 displays, for example, the number of fastening parts for which the fastening operation has been performed.

### (2-2-12) Connector

The power supply connector 95 is a component to which a power supply cable is to be electrically connected. Through the power supply cable, the electric power is supplied to the electric tool 1. The communication connector 96 is a component to which a communication cable is to be connected. The communication cable allows the communication interface 92 of the electric tool 1 and the communication interface C11 of the external device C1 to communicate with each other. The power supply connector 95 and the communication connector 96 are disposed at an upper portion of the electric tool 1. More specifically, the power supply connector 95 and the communication connector 96 are disposed on an upper end surface of the first part 21 of the housing 2.

### (2-3) External Device

The external device C1 is a device configured to: determine whether or not the fastening operation has normally been performed by the electric tool 1; and transmit the determination result to the electric tool 1. The external device C1 of the present embodiment includes the communication interface C11, an estimator C12, and the determiner C13.

The communication interface C11 communicates with the communication interface 92 of the electric tool 1. More specifically, the communication interface C11 receives data on the motor current value transmitted from the communication interface 92 of the electric tool 1. The communication interface C11 outputs the data, thus received, on the motor current value to the estimator C12.

From the data on the motor current value received from the communication interface C11, the estimator C12 calculates the rotational velocity, a change in rotation amount, and the like of the motor 3. Based on a calculation result, the estimator C12 estimates the value of fastening torque which is applied to the fastening part when the clutch 8 operates. That is, the estimator C12 estimates, based on the motor current value when the clutch 8 operates, the value of the fastening torque, which is applied to the fastening part when the clutch 8 operates.

The determiner C13 determines, based on the value of the fastening torque estimated by the estimator C12, whether or not the fastening operation has normally been performed. More specifically, the determiner C13 determines whether or not the value of the fastening torque estimated by the estimator C12 is within a set range set in advance, and if the value is within the set range, the determiner C13 determines that the fastening operation has normally been performed. In contrast, the determiner C13 determines whether or not the value of the fastening torque estimated by the estimator C12 is within the set range set in advance, and if the value is out of the set range, the determiner C13 determines that the fastening operation has not normally been performed. As an example, the set range is set such that the set range includes a predetermined error range from a target value of the fastening torque of the fastening operation. The communication interface C11 transmits the determination result by the determiner C13 to the communication interface 92 of the electric tool 1.

### (3) Operation

With reference to the sequence diagram of FIG. 6, operation of the electric tool 1 and the external device C1 in the present embodiment until the first display 5 displays whether or not the fastening operation has normally been performed will be described.

First of all, the electric tool 1 starts the fastening operation (S1). More specifically, the worker tilts the operating member 6 toward the grip 22 in the state where the tip tool B1 held by the holder 4 is in contact with the fastening part, and thereby, the electric tool 1 starts the fastening operation. Then, when the fastening torque value of the fastening operation reaches the target value, the clutch 8 operates to mechanically interrupt the transmission of the rotational force to the tip tool B1 (S2). Thereafter, the worker returns the operating member 6 to a position which the operating member 6 took at a time point before a start of the fastening operation, and thereby, the electric tool 1 ends the fastening operation (S3). The communication interface 92 of the electric tool 1 transmits, to the communication interface C11 of the external device C1, data on the motor current value, which is the value of the current which flows through the motor 3 when the clutch 8 operates.

Then, the communication interface C11 of the external device C1 receives the data on the motor current value from the communication interface 92 of the electric tool 1 (S5) and outputs the data to the estimator C12. The estimator C12 calculates, based on the motor current value received by the communication interface C11, the rotational velocity, the change in rotation amount, and the like of the motor 3, and estimates the value of the fastening torque, which is applied to the fastening part when the clutch 8 operates (S6). The determiner C13 determines, based on the value of the fastening torque estimated by the estimator C12, whether or not the fastening operation has normally been performed (S7). Thereafter, the communication interface C11 of the external device C1 transmits the determination result by the determiner C13 to the communication interface 92 of the electric tool 1 (S8).

The communication interface 92 of the electric tool 1 receives the determination result by the determiner C13 from the communication interface C11 of the external device C1 (S9) and outputs the determination result to the first display 5. The first display 5 displays the determination result by the determiner C13 (S10). That is, the first display 5 displays whether or not the fastening operation has normally been performed. Specifically, if the estimator C12 determines that the fastening operation has normally been performed, the first display 5 of the present embodiment outputs green light. In contrast, if the estimator C12 determines that the fastening operation has not normally been performed, the first display 5 of the present embodiment outputs red light.

The sequence diagram of FIG. 6 is a mere example of the operation of the electric tool 1 and the external device C1 of the present embodiment, and the order of the processes may accordingly be exchanged, or any of the processes may accordingly be omitted.

### (4) Variations

Variations of the first embodiment described above will be enumerated below. The variations described below may be accordingly combined with each other.

The first display 5 of the embodiment described above switches, in accordance with the state of the fastening operation, the color of light output therefrom to any one of the plurality of colors. However, the first display 5 may be configured to display at least one of characters, numerical digits, or symbols, and in accordance with the state of the fastening operation, the first display 5 may display at least one of the characters, the numerical digits, or the symbols. Specifically, the first display 5 may be a liquid crystal display or an organic EL display configured to display at least one of the characters, the numerical digits, or the symbols. This configuration provides the advantage that grasping the state of the fastening operation is facilitated.

For example, if the estimator C12 determines that the fastening operation has normally been performed, the first display 5 may display a string of the characters such as “normal” or “OK”, or a symbol such as “o”. In contrast, if the estimator C12 determines that the fastening operation has not normally been performed, the first display 5 may display a string of the characters such as “abnormal” or “NG”, or a symbol such as “X”.

Moreover, the first display 5 may have a function of the second display 93 and may display, for example, the number of fastening parts and the like for which the fastening operation has been performed.

Note that the first display 5 may be configured such that the outer surface of the transmission cover 53 has holes in the shape of characters, numerical digits, or symbols, and the character(s), the numerical digit(s), or the symbol(s) emerges when the light-emitting elements 51 output light.

Moreover, the first display 5 of the embodiment described above has the shape extending over the entire circumference of the outer surface of the stopper 23. However, the electric tool 1 may include a plurality of first displays 5, and the plurality of first displays 5 may be disposed at intervals along the circumferential direction of the outer surface of the stopper 23.

Moreover, the first display 5 of the embodiment described above includes the two light-emitting elements 51 but may include one light-emitting element 51 or three or more light-emitting elements 51. That is, the number of light-emitting elements 51 is not limited.

Moreover, the first display 5 of the embodiment described above includes the two light-emitting elements 51, the holding pedestal 52, and the transmission cover 53. However, as long as the first display 5 can display the state of the fastening operation, the structure of the first display 5 is not limited. For example, the first display 5 may include one or more light-emitting elements directly disposed on the outer surface of the stopper 23. Specifically, the electric tool 1 may include, as the first display 5, a color-tunable LED element directly disposed on the outer surface of the stopper 23.

The communication interface 92 of the embodiment described above transmits, to the communication interface C11 of the external device C1, data on the motor current value when the clutch 8 operates. However, the communication interface 92 may transmit, to the communication interface C11 of the external device C1, data on a motor current value immediately before the clutch 8 operates. In this case, the estimator C12 of the external device C1 estimates, based on the data on the motor current value immediately before the clutch 8 operates, the value of the fastening torque which is applied to the fastening part immediately before the clutch 8 operates.

Moreover, the communication interface 92 may transmit, to the communication interface C11 of the external device C1, data on a motor current value in a time period from when the electric tool 1 starts the fastening operation until the clutch 8 operates. In this case, the estimator C12 of the external device C1 estimates, based on the data on the motor current value in the time period from when the electric tool 1 starts the fastening operation until the clutch 8 operates, a maximum value of the fastening torque which is applied to the fastening part in the time period from when the electric tool 1 starts the fastening operation until the clutch 8 operates.

### Summary

An electric tool (1) of a first aspect includes a motor (3), a holder (4), a display (5), and a housing (2). The motor (3) is configured to perform rotation operation. The holder (4) is configured to hold a tip tool (B1) to which a rotational force is to be transmitted from the motor (3). The display (5) is configured to display a state of a fastening operation of fastening a fastening part to a work target by the tip tool (B1). The housing (2) houses the motor (3). The housing (2) includes a grip (22) and a stopper (23). The grip (22) has an elongated shape and is configured to be gripped by a person. The stopper (23) is disposed at an end (221) of the grip (22), the end (221) being located at a side of the holder (4), the stopper (23) protruding beyond the end (221) in a protrusion direction intersecting a longitudinal direction of the grip (22). The display (5) being disposed on the stopper (23).

This aspect provides the advantage that checking the state of the fastening operation is further facilitated.

In an electric tool (1) of a second aspect referring to the first aspect, the stopper (23) protrudes in the protrusion direction from an entire circumference of the end (221).

This aspect provides the effect that the hand of the worker is suppressed from slipping downward from the grip (22) during the fastening operation. This consequently provides the advantage that the display (5) disposed on the stopper (23) is suppressed from being hidden by the hand of the worker during the fastening operation.

In an electric tool (1) of a third aspect referring to the second aspect, the display (5) has a shape extending over an entire circumference of an outer surface of the stopper (23).

This aspect provides the advantage that the worker can check the state of the fastening operation regardless of the position which the worker performing the fastening operation takes.

In an electric tool (1) of the fourth aspect referring to any one of the first to third aspects, the display (5) is configured to display whether or not the fastening operation has normally been performed.

This aspect provides the advantage that the worker can check whether or not the fastening operation has normally been performed.

An electric tool (1) of a fifth aspect referring to any one of the first to fourth aspects further includes a clutch (8). The clutch (8) is configured to mechanically interrupt transmission of the rotational force to the tip tool (B1) when a fastening torque value of the fastening operation reaches a target value. The clutch (8) is disposed between the stopper (23) and the holder (4).

This aspect provides the advantage that even when a part of the work target where the fastening part is to be fastened is recessed, the work target is suppressed from hiding the display (5).

In an electric tool (1) of a sixth aspect referring to any one of the first to fifth aspects, the display (5) is configured to output light in a plurality of colors individually. The display (5) is configured to switch, in accordance with the state of the fastening operation, a color of the light which the display (5) outputs to any one of the plurality of colors.

This aspect provides the advantage that the worker can easily check the fastening operation.

In an electric tool (1) of a seventh aspect referring to any one of the first to sixth aspects, the display (5) is configured to display at least one of a character, a numerical digit, or a symbol.

This aspect provides the advantage that grasping the state of the fastening operation is facilitated.

### REFERENCE SIGNS LIST

1 Electric Tool
2 Housing
22 Grip
221 End
23 Stopper
3 Motor
4 Holder
5 First Display (Display)
8 Clutch
B1 Tip Tool

1. An electric tool comprising:
a motor configured to perform rotation operation;
a holder configured to hold a tip tool to which a rotational force is to be transmitted from the motor;
a display configured to display a state of a fastening operation of fastening a fastening part to a work target by the tip tool; and
a housing housing the motor,
the housing including
a grip having an elongated shape and configured to be gripped by a person and
a stopper being disposed at an end of the grip, the end being located at a side of the holder, the stopper protruding beyond the end in a protrusion direction intersecting a longitudinal direction of the grip,
the display being disposed on the stopper.

2. The electric tool of claim 1, wherein
the stopper protrudes in the protrusion direction from an entire circumference of the end.

3. The electric tool of claim 2, wherein
the display has a shape extending over an entire circumference of an outer surface of the stopper.

4. The electric tool of claim 1, wherein
the display is configured to display whether or not the fastening operation has normally been performed.

5. The electric tool of claim 1, further comprising a clutch configured to mechanically interrupt transmission of the rotational force to the tip tool when a fastening torque value of the fastening operation reaches a target value, wherein
the clutch is disposed between the stopper and the holder.

6. The electric tool of claim 1, wherein
the display is configured to
output light in a plurality of colors individually.
switch, in accordance with the state of the fastening operation, a color of the light which the display outputs to any one of the plurality of colors.

7. The electric tool of claim 1, wherein
the display is configured to display at least one of a character, a numerical digit, or a symbol.

8. The electric tool of claim 2, wherein the display is configured to display whether or not the fastening operation has normally been performed.

9. The electric tool of claim 3, wherein
the display is configured to display whether or not the fastening operation has normally been performed.

10. The electric tool of claim 2, further comprising a clutch configured to mechanically interrupt transmission of the rotational force to the tip tool when a fastening torque value of the fastening operation reaches a target value, wherein
the clutch is disposed between the stopper and the holder.

11. The electric tool of claim 3, further comprising a clutch configured to mechanically interrupt transmission of the rotational force to the tip tool when a fastening torque value of the fastening operation reaches a target value, wherein
the clutch is disposed between the stopper and the holder.

12. The electric tool of claim 4, further comprising a clutch configured to mechanically interrupt transmission of the rotational force to the tip tool when a fastening torque value of the fastening operation reaches a target value, wherein
the clutch is disposed between the stopper and the holder.

13. The electric tool of claim 2, wherein
the display is configured to
output light in a plurality of colors individually.
switch, in accordance with the state of the fastening operation, a color of the light which the display outputs to any one of the plurality of colors.

14. The electric tool of claim 3, wherein
the display is configured to
output light in a plurality of colors individually.
switch, in accordance with the state of the fastening operation, a color of the light which the display outputs to any one of the plurality of colors.

15. The electric tool of claim 4, wherein
the display is configured to
output light in a plurality of colors individually.
switch, in accordance with the state of the fastening operation, a color of the light which the display outputs to any one of the plurality of colors.

16. The electric tool of claim 5, wherein
the display is configured to
output light in a plurality of colors individually.
switch, in accordance with the state of the fastening operation, a color of the light which the display outputs to any one of the plurality of colors.

17. The electric tool of claim 2, wherein
the display is configured to display at least one of a character, a numerical digit, or a symbol.

18. The electric tool of claim 3, wherein
the display is configured to display at least one of a character, a numerical digit, or a symbol.

19. The electric tool of claim 4, wherein
the display is configured to display at least one of a character, a numerical digit, or a symbol.

20. The electric tool of claim 5, wherein
the display is configured to display at least one of a character, a numerical digit, or a symbol.
